(19) United States
(12) Patent Application Publication
(10) Pub. No.: US 2010/0006060 A1
(43) Pub. Date: Jan. 14, 2010

(54) High Pressure Injection Arrangement for an Internal Combustion Engine with Direct Injection

(76) Inventor: Dirk Hoefner, Wellheim (DE)

Correspondence Address: Novak Druce & Quigg LLP, 1300 I Street NW, Suite 1000 West Tower, Washington, DC, 20005, US

(21) Appl. No.: 12/500,435

(22) Filed: Jul. 9, 2009

(30) Foreign Application Priority Data
Jul. 9, 2008 (DE) 10 2008 032 385.3

(51) Int. Cl. F02B 75/00; F02M 61/14

(52) U.S. Cl. 123/294; 123/470

(57) ABSTRACT

The invention relates to a high pressure injection arrangement for an internal combustion engine with direct injection, with an injection valve and a support element, which supports the injection valve in the installed state on a seat of an internal combustion engine. It is provided that a spring element is arranged between the injection valve and the support element.

The invention relates to a high pressure injection arrangement for an internal combustion engine with direct injection with an injection valve and a support element, which supports the injection valve in the installed state on a seat of an internal combustion engine.

### BACKGROUND OF THE INVENTION

High pressure injection arrangements of internal combustion engines with direct injection, which have injection valves based on solenoid valve technology, develop high momenta during operation by the solenoid striking its end stops when the valve opens and closes, momenta that are transferred via the housing of the injection valve and the support element to the internal combustion engine and thus result in a noise emission that is perceptible by humans. In particular by reflection of free, oscillating surfaces in or on the cylinder head of the internal combustion engine, thus excited sound pulses that are very readily perceptible by humans are emitted. Because of the high opening and closing frequency of such injection valves, this sound frequency is in a relatively high frequency range that is considered to be very unpleasant to the human ear. Moreover, a clarion, mechanical striking noise, a “ticking,” is perceptible. To minimize this undesirable sound pulse, it is known to provide elastic arrangements in the area in which the injection valve is supported on the cylinder head. For example, an arrangement in which a support element, namely a seat ring, supports the injection valve in the cylinder head is known from EP 1 134 406 B1. In the arrangement that is described there, it is disadvantageous that the seat ring and the spring element are spaced far apart from one another and that the bow-shaped spring element is suspended in a ring around the housing, i.e., ultimately provides no effective momentum damping but rather serves primarily as a fastening device. The latter, in particular in the radial respect, claims considerable installation space and requires a design of the spring element in the area of an electric connection and/or the connection of a fuel line in the end area of the injection valve. In particular, in this connection, the actual momentum transfer via the seat ring to the cylinder head is not effectively suppressed.

The object of the invention is to provide a high pressure injection arrangement that avoids the above-mentioned drawbacks and offers as complete elimination as possible of mechanical momentum input that leads to undesirable acoustic phenomena, due in particular to solid-borne sound conduction or excitation of oscillating surfaces in the engine block, in particular the cylinder head of the internal combustion engine.

### SUMMARY OF THE INVENTION

In this way, a high pressure injection arrangement for an internal combustion engine with direct injection is proposed with an injection valve and a support element that supports the injection valve in the installed state on a seat of an internal combustion engine. In this connection, it is provided that a spring element is arranged between the injection valve and the support element. In this connection, the injection valve is held in a support element that supports the injection valve in its installed state on the seat of the internal combustion engine that is intended for it. A spring element is arranged between the injection valve and the support element. Accordingly, unlike in the prior art, the momentum that is produced by the solenoid valve of the injection valve is not transferred from the housing of the injection valve directly to the support element, as a result of which the damping or even the extinction of the momentum can take place only to the extent allowed by the material and design of the support element, but rather the momentum is first transferred to a spring element that is arranged between the support element and the injection valve and from the latter to the support element. In this way, a considerable portion of the momentum in the spring element is already consumed. The support element is therefore only affected by momentum to a far lesser extent than in the prior art, so that its share of the residual momentum to be damped is relatively small.

The spring element is preferably a spring washer. In this connection, the spring element is designed essentially flat, specifically, as a spring washer, here a spring washer being also defined as a lock washer, i.e., a spring washer with an essentially central opening.

It is further provided in one embodiment that the spring washer has an inside ring zone and an outside ring zone, with the inside ring zone resting on the injection valve in a first contact area and the outside ring zone resting on the support element in a second contact area. The first contact area is consequently the contact area in which the injection valve is in close contact with the inside ring zone of the spring washer, while the second contact area is the one in which the outside ring zone contacts the support element. The spring washer is consequently designed as a ring, namely as a lock washer, which is centrally penetrated by the injection valve, which is made, for example, stepped. In this connection, the inside ring zone rests on the injection valve and thus forms the first contact area. The outside ring zone rests on the support element and thereby mediates the support of the injection valve via the spring washer on the support element in the second contact area. It is essential in this connection that the injection valve not rest directly on the support element and preferably also in such a way that the first contact area and the second contact area, viewed in axial extension of the injection valve, are not aligned. In this way, solid-borne sound transfer or momentum input by the injection valve into the cylinder block, namely via the support element, is very effectively prevented.

The first contact area is preferably a first line contact area. By means of the line contact area, an essentially pure line-shaped contact formation can be achieved, so that a large-area contact is avoided, and a geometrically exactly defined momentum input into the spring washer takes place via the spatially very concentrated local pressure that develops in this connection when the momentum strikes the line contact area.

The second contact area is especially preferably a second line contact area. In this connection, what is stated for the first line contact area applies accordingly.

In another, especially preferred design, the first contact area is at a radial distance from the second contact area. In this respect, a kind of lever by which the injection valve is kept elastic/suspended relative to the injection valve, i.e., can spring in and out in particular in the axial direction, is formed between the first contact area and the second contact area, in particular namely the first line contact area and the second line contact area. In this way, direct momentum input by the injection valve onto the support element and via the latter into the cylinder head is avoided. By this arrangement, a spring-mass system is also formed, by which any momentum can be degraded as a damped oscillation.

In one embodiment, the spring element consists of steel. In particular, the use of commonly used spring steel or else ordinary steel, for example a washer, is considered. For this application, steel has very good elasticity and strength values.

It is preferably provided that the support element consists of plastic. In this way, self-damping of the support element can be produced, namely by the selection of the plastic material, as a result of which the residual momentum that is still introduced into the support element can be advantageously damped, so that the latter is not introduced into the cylinder head (or only to a very small extent). The embodiment of a plastic support element without the spring element according to the invention would be conceivable in principle, but in this connection the support element would have to be designed especially large to achieve an only approximately similarly good damping value, which could produce, on the one hand, installation space problems, and, on the other hand, accuracy problems, in particular in the assembly and in the achievable seat of the internal combustion engine; such a support element, taken by itself, would not be able to achieve the proposed high momentum damping.

In another embodiment, the support element is a cage element. Thus, it is meant that the support element encompasses the injection valve at least in certain areas. In particular, it is provided to design the cage element such that the support element has a seat ring that locks in support element holding devices of the injection valve, for example, with clips or clip arms that are extended on the cage element on the outside in the axial direction of the injection valve. Thus, a very simple and reliable mounting of the support element on the injection valve can be achieved; in particular, the injection valve can be preassembled with the support element and the spring washer or the spring element stored therein and is thus available as a subassembly for installation in the internal combustion engine.

### BRIEF DESCRIPTION OF THE DRAWINGS

FIG. 1 shows a three-dimensional visualization of the injection valve, and

FIG. 2 shows a sectional view of the injection valve in the installed state.

### DETAILED DESCRIPTION OF THE PREFERRED EMBODIMENTS OF THE INVENTION

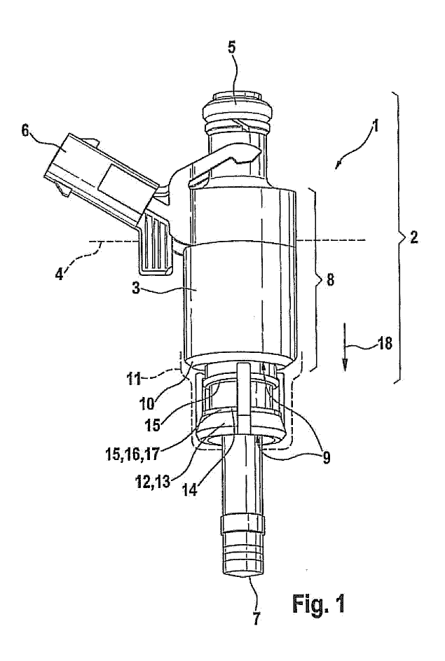

FIG. 1 shows an injection valve 1 for a high pressure injection unit of a motor vehicle, not shown, with a housing 3 that is designed as a stepped cylinder 2 in the broadest sense, and said housing is used in, for example, a belt line 4 in an engine of an internal combustion engine, not shown, in particular in the area of a cylinder head (not shown in FIG. 1). Above the belt line 4, the injection valve I has a fuel connection 5 as well as an electric connection 6 for connection to the fuel supply and control system of the motor vehicle. The housing 3 is tapered on the end that faces away from the fuel connection 5, in multiple stages up to the formation of an injection nozzle 7, which introduces the fuel to be injected into the combustion chamber of the internal combustion engine. In this connection, the housing 3 can be divided into the valve base 8 and then, toward the injection nozzle, two ring stages 9 for forming the stepped cylinder 2, whereby the ring stages 9 have support surfaces 10 pointing in the direction toward the injection nozzle 7. On the support surfaces 10, the attachment of the injection valve 1 to a seat 11 of the internal combustion engine is carried out. In the area of the ring stage 9 that lies closest to that of the injection nozzle 7, the injection valve 1 is held by a support element 12 that surrounds the housing 3 like a cage element 13 in this area. In this way, a spring element 15, which surrounds the injection valve 1 like a ring in the area of the ring element 9 that is surrounded by the cage element 13 in the form of a spring washer 16, in particular a lock washer 17, is arranged between the injection valve 1 and the support element 12 to form an elastic bearing 14. In this way, a momentum 18 that has developed during the operation of the injection valve 1 by the electromagnets of the injection valve 1, not shown, and that would be introduced in the axial direction of the injection valve 1 via the seat 11 into the cylinder head, not shown here, is elastically absorbed.

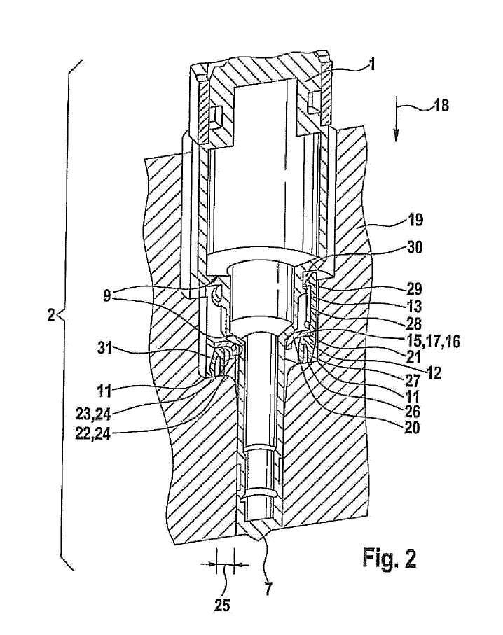

FIG. 2 shows sections of the injection valve 1 in cross-section how the valve is installed in the seat 11 of a cylinder head 19 of the internal combustion engine in the installation position. The injection valve 1 is designed as a stepped cylinder 2, with the ring stages 9 being present with diameter tapering in the direction toward the injection nozzle 7. The ring stage 9 that lies closest to the injection nozzle 7 presses the spring element 15, namely the lock washer 17. In this connection, the lock washer 17, namely the spring washer 16, has an inside ring zone 20 and an outside ring zone 21. In this connection, the outside ring zone 21 rests on the support element 12, while the inside ring zone 20 rests on the injection valve 1. As it rests against the injection valve 1, the inside ring zone 20 forms a first contact area 22, and while it rests against the support element 12, the outside ring zone 21 forms a second contact area 23. Both the first contact area 22 and the second contact area 23 are in each case line contact areas 24. This means that an essentially line-shaped arrangement exists. In this connection, the first contact area 22 and the second contact area 23 are at a radial distance 25 from one another. The spring element 15 is consequently held between the first contact area 22 and the second area 23 like a rotating lever, and together with the mass of the injection valve 1, a spring-mass system is created, by which the momentum 18, which is transferred in the direction toward the injection nozzle 7 from the injection valve 1 to the seat 11 in the cylinder head 19, is effectively damped. Here, as described, the support element 12 is designed as a cage element 13, whereby in the area of the seat 11, namely on a stepped support surface 26 in the cylinder head 19, on which it is supported, it is designed as a seat ring 27, which encompasses the injection valve 1 in a circular manner in the area of the ring stage 9 that lies closest to that of the injection nozzle 7. The seat ring 27 has axial struts 28 that are designed to extend from the seat ring 27 in the axial extension of the injection valve 1 and that at the injection valve 1 run in the direction away from the injection nozzle 7 up to the second ring stage 9. The latter have snap hooks 29 that engage in a circumferential groove 30 at the injection valve 1 or in correspondingly shaped recesses at the injection valve 1 and in this way attach the support element 12 to the injection valve 1. The shape of the cage element 13 is created by this design. The seat ring 27, for its part, has a structure that is formed essentially as an inverted U 31 in the direction toward the stepped support surface 26, as a result of which in turn an improved, elastic support of the support element 12 on the stepped support surface 26 is produced. The support element 12 is preferably made from a plastic, and the spring element 15 is preferably made from steel. In combining these materials, advantageous, very good momentum and oscillation damping can be achieved, so that the momentum 18 is not transferred or is transferred only to a very small extent to the cylinder head 19.

1. A high pressure injection arrangement for an internal combustion engine with direct injection, with an injection valve and a support element, which supports the injection valve in the installed state on a seat of an internal combustion engine, comprising a spring element is arranged between the injection valve and the support element.

2. The injection arrangement according to claim 1, wherein the spring element is a spring washer.

3. The injection arrangement according to claim 1, wherein the spring washer has an inside ring zone and an outside ring zone, the inside ring zone resting on the injection valve in a first contact area, and the outside ring zone resting on the support element in a second contact area.

4. The injection arrangement according to claim 3, wherein the first contact area is a first line contact area.

5. The injection arrangement according to claim 3, wherein the second contact area is a second line contact area.

6. The injection arrangement according to claim 3, wherein the first contact area is at a radial distance from the second contact area.

7. The injection arrangement according to claim 1, wherein the spring element consists of steel.

8. The injection arrangement according to claim 1, wherein the support element consists of plastic.

9. The injection arrangement according to claim 1, wherein the support element is a cage element.

10. A high pressure fuel injection valve insertable in an opening through the engine block of an internal combustion engine, having an enlarged section providing a peripheral support surface, comprising:
a housing insertable in said enlarged section of said block, having a passageway provided with an inlet port connectable to a fuel supply, an outlet and a solenoid operated valve therebetween;
a nozzle depending from said housing and communicable with said passageway, disposable in said engine block opening when said housing is inserted in said enlarged section of said opening;
a sound attenuating member disposable about a periphery of said housing supportable on said support surface of said enlarged opening when said valve is inserted in said opening; and
a washer having an opening receiving said nozzle therethrough, an outer portion supportable on a surface of said sound attenuating member and an inner portion supporting a portion of said housing, when said injection valve is inserted in said opening.

11. A fuel injection valve according to claim 10 wherein said sound attenuating member is formed of a plastic and said washer is formed of a metal.

12. A fuel injection valve according to claim 1 wherein said sound attenuating member includes an annular surface disposed at an angle relative to a centerline of said nozzle when said injection valve is disposed in said opening, on which said outer portion of said washer is supported.

13. A fuel injection valve according to claim 10 wherein said housing includes an annular surface relative to a centerline thereof which is supported on said inner portion of said washer when said valve is disposed in said opening.

14. A fuel injection valve according to claim 10 wherein said sound attenuating member includes an annular grove in a surface supportable on said annular support surface.

15. A fuel injection valve according to claim 10 wherein said housing includes an annular outwardly opening groove in a side surface thereof, and said sound attenuating member includes a laterally protruding portion functional to snap-fit into said groove.

16. An assembly insertable in an enlarged section of an opening through an engine block of an internal combustion engine, in which a housing having a nozzle, a passageway intercommunicating an inlet part and said nozzle and a solenoid-operated valve, is insertable, comprising:
a sound attenuating member disposable about a periphery of said housing when said injection valve is inserted in said opening, supportable on a peripheral surface provided by said enlarged section of said opening; and
a washer disposable in said enlarged section of said opening having an opening receiving said nozzle therethrough, an outer portion supportable on a surface of said sound attenuating member and an inner portion supporting a portion of said housing, when said sound attenuating member, said washer and said injection valve are disposed in said engine block opening.

17. An assembly according to claim 16 wherein said sound attenuating member is formed of a plastic and said washer is formed of a metal.

18. An assembly according to claim 16 wherein said sound attenuating member includes an annular surface disposed at an angle relative to a centerline of said nozzle when said injection valve and assembly are disposed in said opening, on which said outer portion of said washer is supported.

19. An assembly according to claim 16 wherein said inner portion of said washer includes a seating surface for an annular surface of said housing when said assembly and injection valve are disposed in said opening.

20. An assembly according to claim 16 wherein said sound attenuating member includes a laterally protruding potion functional to snap-fit into an annular, outwardly opening groove in a side surface of said housing, when said assembly and said injection valve are disposed in said engine block opening.
